(19) United States
(12) Patent Application Publication
(10) Pub. No.: US 2019/0220252 A1
(43) Pub. Date: Jul. 18, 2019

(54) SYSTEM AND METHOD FOR DEFINING AND GENERATING REQUIREMENT DATA FROM INPUT

(71) Applicant: BLUEPRINT SOFTWARE SYSTEMS INC., Toronto (CA)

(72) Inventors: Tony HIGGINS, Toronto (CA); Sean MOTLAGH, Toronto (CA); Jason BENFIELD, Toronto (CA)

(21) Appl. No.: 15/999,852

(22) PCT Filed: Feb. 17, 2017
(86) PCT No.: PCT/IB2017/050927

§ 371 Date: Aug. 20, 2018

Related U.S. Application Data
(60) Provisional application No. 62/296,760, filed on Feb. 18, 2016.

(51) Int. Cl. G06F 8/10; G06F 8/20; G06F 17/24

(52) U.S. Cl. CPC G06F 8/10; G06F 17/243; G06F 8/20

(57) ABSTRACT

Automatic generation of output requirement data from task records includes: presenting at least one input interface having: a first region including an actor input field and an action input field; a second region including a system action input field; receiving (i) first input data corresponding to the actor filed; (ii) second input data corresponding to the action field, and (iii) third input data corresponding to the system action input field; storing the first input data, the second input data, and the third input data in a task record; receiving a requirement data type; retrieving a set of conversion rules corresponding to the received requirement data type; generating, based on the task record and the retrieved conversion rules, at least one element of output requirement data having the received input requirement data type; and presenting the at least one element of output requirement data.

### CROSS-REFERENCE TO RELATED APPLICATIONS

This application claims priority to U.S. provisional application no. 62/296760, filed Feb. 18, 2016, the contents of which are incorporated herein by reference.

### FIELD

The specification relates generally to requirement data for software application design, and specifically to a system and method for generating requirement data from input records.

### BACKGROUND

Many software development projects, particularly in early stages of development or before development has begun, include a requirements gathering process. This process involves collecting, often from various stakeholders (e.g. end users, programmers, and the like), data describing the desired behaviour and functionality of the planned software application. This data can be generally referred to as requirements, and can have a significant impact on subsequent development of the application. The impact can be a negative one, when the requirements gathered previously were incomplete or unclear.

Various tools have been developed to store, view and modify requirements for software application development. However, the initial collection of input data defining those requirements remains inefficient and vulnerable to the introduction of errors or ambiguity.

### BRIEF DESCRIPTIONS OF THE DRAWINGS

Embodiments are described with reference to the following figures, in which:

FIG. 1 depicts a system for generating requirement data from input records, according to a non-limiting embodiment;

FIG. 2 depicts a method of generating requirement data from input records, according to a non-limiting embodiment;

FIG. 3 depicts an example interface presented in the performance of the method of FIG. 2, according to a non-limiting embodiment;

FIG. 4 depicts the interface of FIG. 3 as populated during the performance of the method of FIG. 2, according to a non-limiting embodiment;

FIGS. 5A-5B depict an additional interface presented in the performance of the method of FIG. 2, according to a non-limiting embodiment;

FIGS. 6A-6B depict the interface of FIG. 5 as populated during the performance of the method of FIG. 2, according to a non-limiting embodiment;

FIG. 7 depicts an interface presented following the population of the interfaces of FIGS. 3 and 5A-5B through the performance of the method of FIG. 2, according to a non-limiting embodiment;

FIG. 8 depicts the creation of an additional input record in the interface of FIG. 7, according to a non-limiting embodiment;

FIG. 9 depicts an updated version of the interface of FIG. 7 generated through the performance of the method of FIG. 8, according to a non-limiting embodiment;

FIG. 10 depicts example data records stored as a result of the performance of the method of FIG. 2, according to a non-limiting embodiment;

FIG. 11 depicts a method of converting input records to requirement data, according to a non-limiting embodiment;

FIG. 12 depicts an example interface presented in the performance of the method of FIG. 11; and

FIG. 13 depicts an example interface presented in the performance of the method of FIG. 2, according to another non-limiting embodiment.

### DETAILED DESCRIPTION OF THE EMBODIMENTS

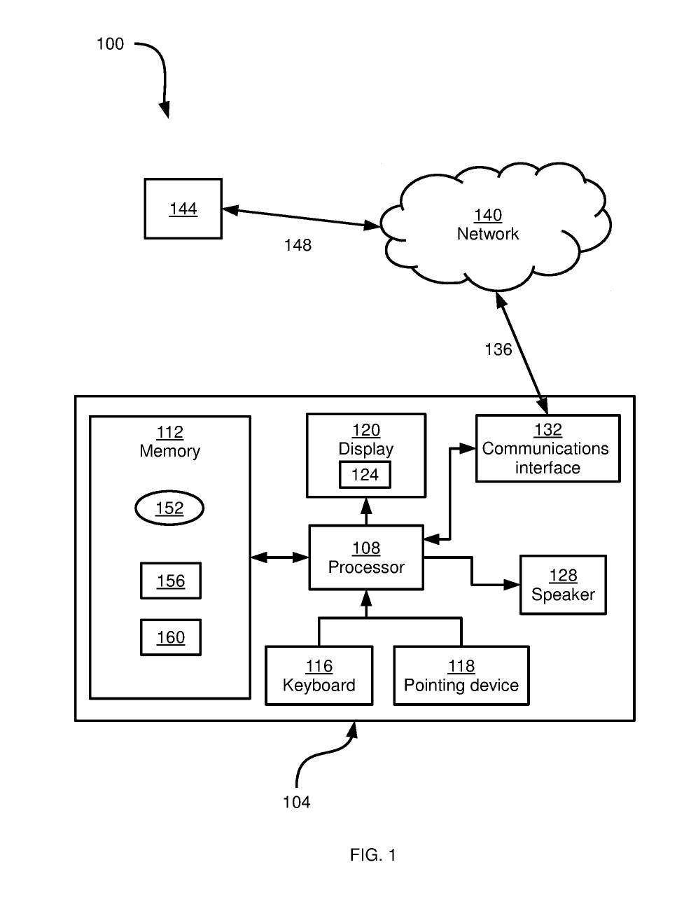

FIG. 1 depicts a system 100 for generating requirement data from input records. System 100 includes a computing device 104 (also referred to herein as device 104), which can be based on any known computing environment. In the present example embodiment, computing device 104 is a personal computer (such as a laptop computer). It is contemplated, however, that in other embodiments, computing device 104 can comprise a server, a collection of servers (i.e. a cloud computing environment), a tablet computer, a desktop computer and the like.

Computing device 104 includes a central processing unit (CPU), also referred to as a processor 108 interconnected with a non-transitory computer readable storage medium such as a memory 112. Memory 112 can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. In general, processor 108 and memory 112 comprise one or more integrated circuits.

Computing device 104 also includes one or more input devices interconnected with processor 108. Such input devices are configured to receive input and provide input data representative of the received input to processor 108. Input devices can include, for example, a keyboard 116 and a pointing device 118, such as a mouse or a touchpad. Thus, keyboard 116 can receive input in the form of key depressions, and provide processor 108 with data representative of such input in the form of American Standard Code for Information Interchange (ASCII) codes corresponding to the depressed keys. As another example, pointing device 118 can receive input in the form of movement across a surface and provide processor 108 with data indicating the speed and direction of movement of pointing device 118. Computing device 104 can include additional input devices in the form of one or more touch screens, light sensors, microphones and the like (not shown). In general, it is contemplated that any suitable combination of the above-mentioned input devices can be connected to processor 108.

Computing device 104 also includes one or more output devices interconnected with processor 108. The output devices of computer 104 include a display 120. Display 120 includes display circuitry 124 controllable by processor 108 for generating interfaces which include representations of data maintained in memory 112. Display 120 can include either or both of a cathode ray tube (CRT) display and a flat panel display comprising any suitable combination of a Liquid Crystal Display (LCD), a plasma display, an Organic Light Emitting Diode (OLED) display, and the like. Circuitry 124 can thus include any suitable combination of display buffers, transistors, electron guns, LCD cells, plasma cells, phosphors, LEDs and the like. In embodiments that include a touch screen input device, the touch screen can be integrated with display 120.

The output devices of computing device 104 can also include a speaker 128 interconnected with processor 108. Additional output devices can also be included.

Computing device 104 also includes a communications interface 132 interconnected with processor 108. Communications interface 132 can include any suitable hardware (e.g. transmitters, receivers, network interface controllers and the like) allowing computing device 104 to communicate with other computing devices via a link 136 and a network 140. Network 140 can include any suitable combination of wired and/or wireless networks, including but not limited to a Wide Area Network (WAN) such as the Internet, a Local Area Network (LAN), cell phone networks, WiFi networks, WiMax networks and the like. Link 136 is compatible with network 140. In the present example embodiment, link 136 is a wired link. In some embodiments, however, link 136 can be a wireless link based on, for example, Institute of Electrical and Electronic Engineers (IEEE) 802.11 (WiFi) or other wireless protocols. It is contemplated that other wireless standards (Global System for Mobile communications (GSM), General Packet Radio Service (GPRS), Enhanced Data rates for GSM Evolution (EDGE), the third and fourth-generation mobile communication system (3G and 4G) and the like) can also be employed.

The various components of computing device 104 are interconnected, for example via one or more communication buses (not shown). Computing device 104 can be supplied with electricity by a wired connection to a wall outlet or other power source. In some examples (not shown), computing device 104 can be powered by a battery interconnected with the components of computing device 104.

System 100 can also include other computing devices, such as a personal computer 144 coupled to network 140 via a link 148. It is contemplated that additional computing devices (not shown) of various types can also be connected to network 140 via respective wired or wireless links.

Computing device 104 stores, in memory 112, a requirement data generator application 152 (also referred to herein as “application 152”), comprising a plurality of computer-readable instructions executable by processor 108. Processor 108, via execution of the instructions of application 152, is configured to provide certain input interfaces on display 120, as will be described below. Processor 108 is further configured to automatically generate various types of output requirement data (e.g. user story data, use case data, test case data, and the like) from input received via the above-mentioned interfaces in connection with the development of a software application (referred to herein as a “new” or “proposed” application, to be distinguished from application 152). To that end, memory 112 also maintains a data store 156 containing a collection of data for the new application, and a set of conversion rules 160.

In general, output requirement data is collected before (for software development following the waterfall model) or during (for software development following the Agile model) the development of a new software application in order to document the desired functionality of the new application, and ensure that during development, the desired functionality represented by the requirements is satisfied.

Output requirement data can take a variety of forms. For example, requirements (also referred to as artifacts) known as user stories are frequently employed in Agile software development. Other examples of commonly employed types of output requirements are use cases (primarily employed in waterfall software development) and test cases. User stories generally define a requirement of the new software application in terms of the functionality expected by a user of the application. User story data will be described below in greater detail. Use case data includes elements describing interactions between a user and a system (that is, the system to be governed by the new application). Test case data, meanwhile, includes test step definitions describing various steps used to test the functionality of the system during execution of the new application. That is, the use case data defines the desired behaviour of the system under the control of the new application, while the test case data provides steps to be performed to ensure that the system behaves as desired under control of the new application.

Other types of output requirement data may also be generated during development of a new application (e.g. simulations and the like). Each type of requirement data can be stored (for example, in memory 112) for later use, such as for presentation on display 120. However, each type of requirement data generally has a different format than the other types of requirement data. That is, each type of requirement data includes elements defined by a certain arrangement of data fields and links between those fields. As will be discussed below, computing device 104 is configured, via the execution of application 152, to receive input data and based on that input data, to generate any of a variety of different types of requirement data, without requiring additional input and in addition, while reducing the volume of initial input data that must be provided to computing device 104.

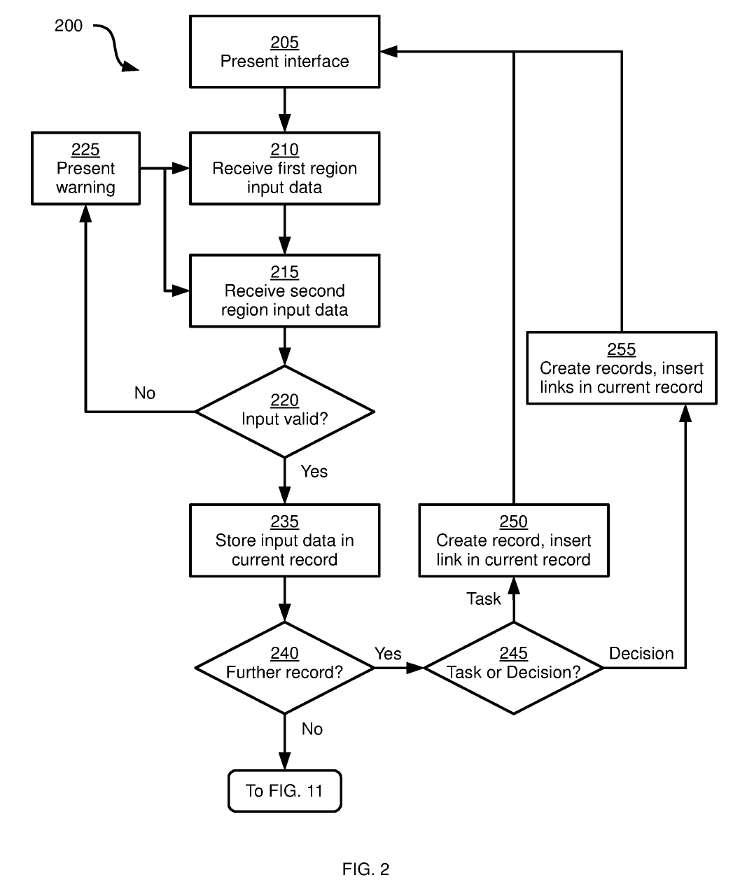

Turning now to FIG. 2, a method 200 of collecting input data for use in generating requirement data from input records is depicted. Method 200 will be discussed in conjunction with its performance on system 100, and more specifically on computing device 104. That is, the blocks of method 200 are performed by computing device 104 via the execution of application 152 by processor 108. In other embodiments, the blocks of method 200 can be executed by other devices, or method 200 can be performed on other suitable systems.

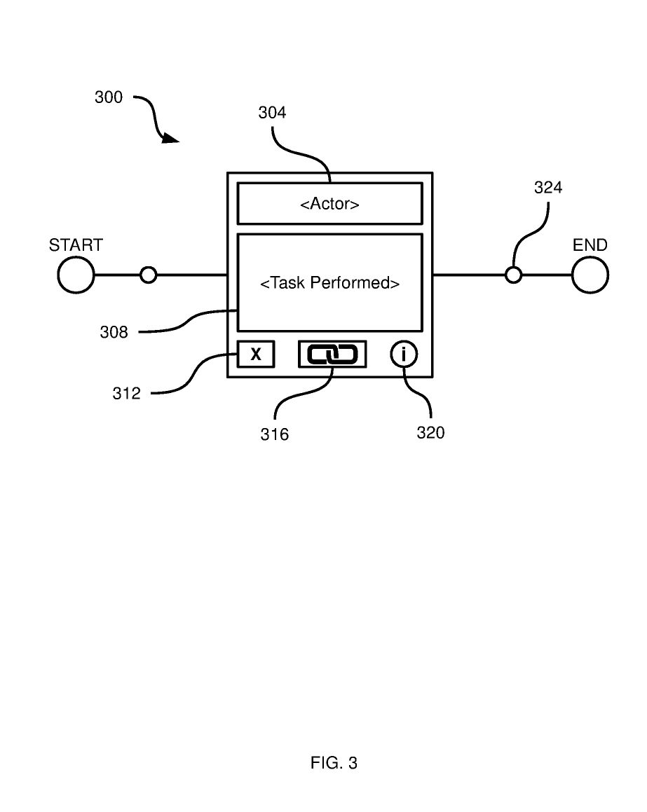

At block 205, processor 108 is configured to control display 120 to present an input interface. An example input interface 300 is shown in FIG. 3, as presented on display 120. Interface 300 includes a first region including an actor input field (also referred to as a role input field) 304 and a task input field 308. Interface 300 also includes a selectable delete element 312 and a selectable sub-process element 316, both of whose functions will be discussed in greater detail below. Further, interface 300 includes a selectable supplementary data element 320, whose function will also be described in further detail below.

Interface 300 can also include a plurality of additional selectable elements. For example, a comments element (not shown) can be selectable to cause device 104 to present a further interface for receiving and displaying text strings defining comments, discussions, notes and the like concerning the task identified in field 308. As a further example, a traces element (not shown; which may also be referred to as a relationships element) can be selectable to cause device 104 to present yet another interface displaying connections stored in memory 104 between the task identified in field 308 and other portions of repository 156 (e.g. other requirement data for the application under development).

Interface 300 can also include a selectable new record element 324. In FIG. 3, two new record elements 324 are shown (one preceding and one following the first region relative to the “start” and “end” labels presented on display 120). In some embodiments, the element 324 preceding the first region can be omitted. The operation of the elements 324 will be described later herein.

Returning to FIG. 2, at block 210 processor 108 is configured to receive input data corresponding to fields 304 and 308. The input data is received from the input devices connected to processor 108 (for example, from keyboard 116). The input data corresponding to field 304 is an identifier of an actor (that is, an identifier of an entity that will use the new application). Processor 108 can be configured, upon receiving a selection of field 304 from an input device such as pointing device 118, to present a plurality of previously configured actor identifiers stored in repository 156 (for example, in a drop-down menu). The receipt of an actor identifier at block 210 can therefore include the selection of an actor identifier from such a drop-down menu.

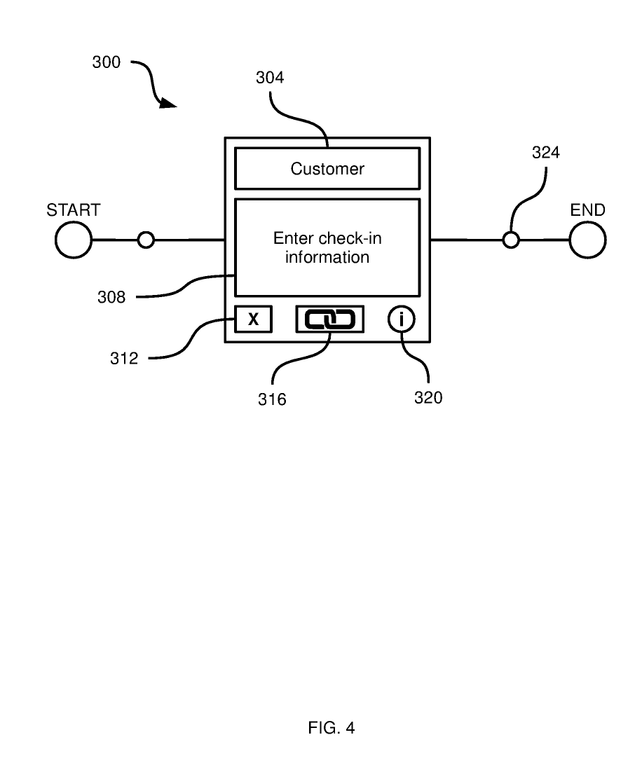

At block 210, processor 108 is also configured to receive input data corresponding to field 308, defining an action (also referred to as a task) performed by the actor identifier selected in field 304. Processor 108 is also configured, as input data is received, to present the input data in the respective fields 304 and 308. Turning to FIG. 4, an updated version of interface 300 is depicted, following the performance of block 210. In particular, fields 304 and 308 contain input data identifying an actor, and an action performed by that actor.

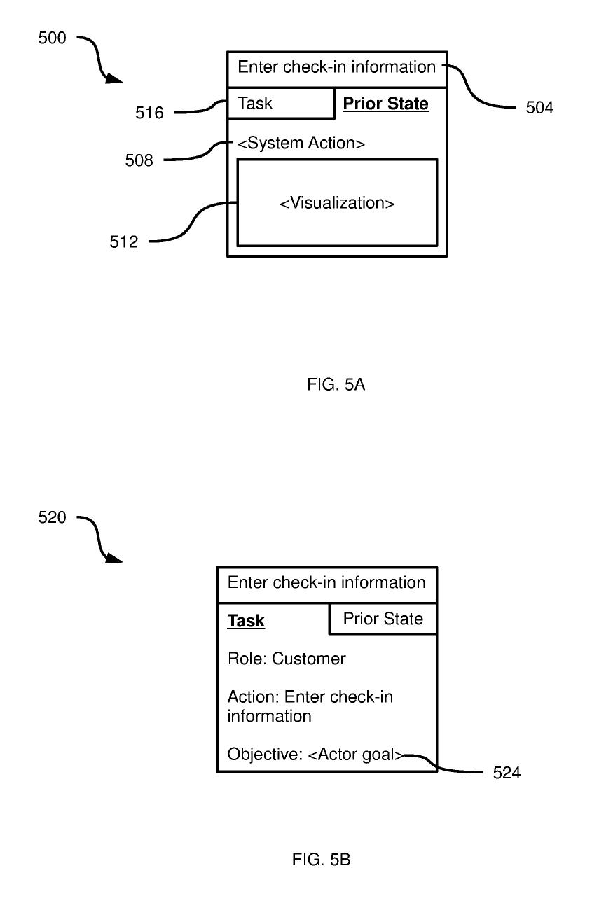

Following the performance of block 210, processor 108 is configured to receive input data from a second input region at block 215. More specifically, in the present embodiment, processor 108 is first configured to present an additional input interface on display 120. The additional input interface can be presented by processor 108 in response to a selection of supplementary data element 320 of interface 300. Turning to FIG. 5A, an example additional input interface 500 is depicted. As illustrated, interface 500 includes an identifier 504 populated automatically with the input data received in field 308 of interface 300.

Interface 500 includes the above-mentioned second region, containing a system action input field 508, and a visualization input field 512. Interface 500 can also include sub-process element 316, as shown in FIG. 4. As with fields 304 and 308, processor 108 is configured to receive input data corresponding to at least field 508. The input data received in connection with field 508 identifies an action performed by the “system” (that is, by the software application under development) to bring the system to its current state (i.e. the state in which the user action specified in field 308 is performed). The input data received in connection with field 512 (if any) includes visualization data. Visualization data, which can include any suitable combination of image data, video data, audio data, and the like, depicts the result of the action defined by the input data received via system action field 508. In other words, the input data received via field 512 provides an illustration of the effect of the input data received in field 504.

As indicated in interface 500, the input data received at fields 508 and 512 define a prior state of the system (i.e. the application under development). Interface 500 can include a further selectable element 516 that, when selected, causes processor 108 to present a further interface 520, shown in FIG. 5B. Interface 520 is automatically populated with the data from fields 304 and 308, and includes another input field 524 for receiving input data defining the desired result of the action from field 308. In some embodiments, field 524 can be omitted. As noted above in connection with interface 500, interface 520 can also include sub-process element 316, as shown in FIG. 4. In some embodiments, interface 520 can include additional fields for collecting additional input data. For example, rather than reproducing the contents of field 308, interface 520 can include one or more additional fields to define the user task. In some examples, the input data received via field 308 provides a label for the task, and interface 520 can include a name field (e.g. for receiving a more detailed task description than the label) and a description field (e.g. for receiving data a longer explanation of the task than the name field or the label field). In the present example, for simplicity of illustration, a single field (308) is employed to receive data describing the task.

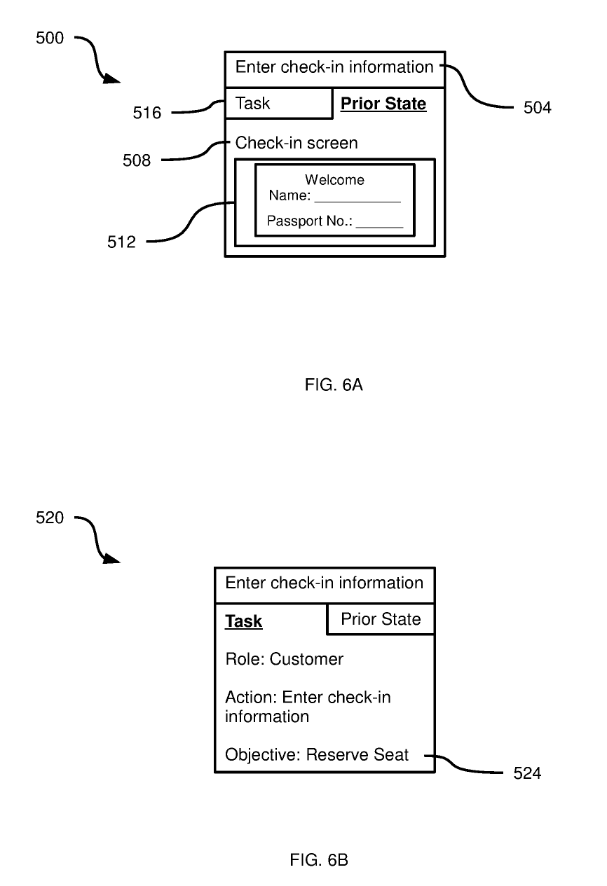

Turning now to FIGS. 6A and 6B, examples of interfaces 500 and 520 are shown, following the receipt of input data corresponding to fields 508, 512 and 524. It will now be apparent that in the present example, the new application under development is an airline check-in application. A wide variety of other applications are also contemplated.

Referring again to FIG. 2, in some examples, following the receipt of input data at block 215, processor 108 can be configured to perform block 220. At block 220, processor 108 is configured to determine whether the input received at blocks 210 and 215 is valid. The determination at block 220 can take a variety of forms. In the present example, the determination is whether at least fields 304, 308 and 508 have been completed. In other embodiments, the determination can also include determining whether field 308 has been completed. In further embodiments, grammatical validation rules, syntax rules, and the like, can also be executed by processor 108 at block 220.

When the determination at block 220 is negative (e.g. field 308 has not been completed), the performance of method 200 proceeds to block 225, at which processor 108 can be configured to present a warning on display 120, and await further input data at one or both of blocks 210 and 215. When the determination at block 220 is affirmative, however, the performance of method 200 proceeds to block 235.

At block 235, processor 108 is configured to store the input data received at blocks 210 and 215 in a task record in memory 112. The storage of input data can also be performed after the receipt of each set of input data. For example, input data received at block 210 can be stored in the record substantially immediately upon receipt, and input data received at each performance of block 215 can also be stored substantially immediately upon receipt, by extending the record already containing the input data from block 210.

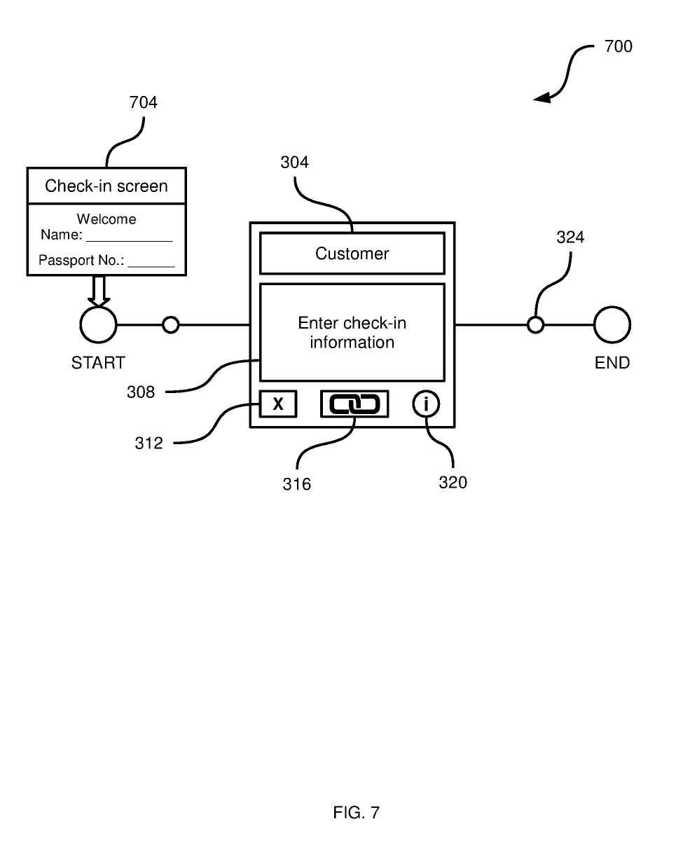

At block 235, processor 108 can also be configured to present on display 120 an updated interface depicting at least some input data from the above-mentioned first and second input regions. Turning to FIG. 7, an example interface 700 is shown including the elements of interface 300 described above, as well as a simplified representation 704 of the elements of interface 500. Representation 704, as mentioned above, contains data defining the prior state of the system at the time the action specified in field 308 is taken. Thus, representation 704 is presented on display 120 in a position that indicates that representation 704 precedes the action of field 308 in time.

As will now be apparent, the input data received by processor 108 thus far defines a system action (e.g. display a check-in screen) and an action performed by a user in response to the system action. For example, according to the input data displayed in FIG. 7, in response to the system displaying a check-in screen, the actor identified as the “customer” enters check-in information (e.g. in the check-in screen visualized in representation 704).

Returning to FIG. 2, following the storage of input data in a record in memory 112, processor 108 is configured to determine whether a further record is to be created, at block 240. The determination at block 240 includes a determination of whether a selection of selectable element 324 has been received at processor 108 (e.g. from pointing device 118). Processor 108 is configured to interpret a selection of selectable element 324 as a command to generate a further task record. Thus, when element 324 is selected, the determination at block 240 is affirmative, and the performance of method 200 proceeds to block 245.

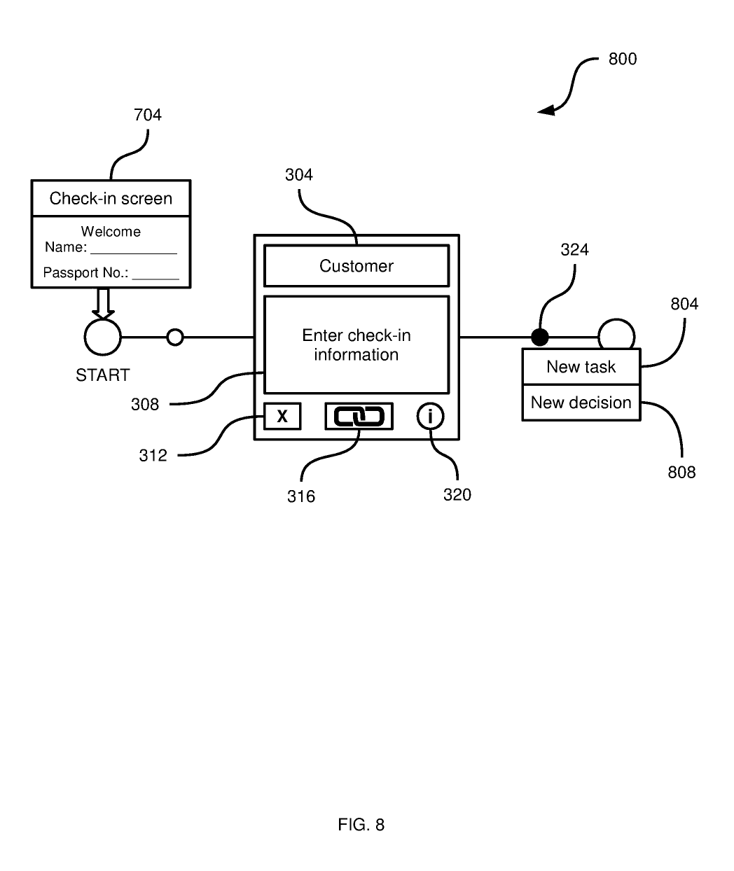

At block 245, processor 108 is configured to determine whether the new record is a single task record (an example of which was described above) or a plurality of task records linked by a decision record. For example, the selection of element 324 (shown in FIG. 3) can cause processor 108 to present on display 120 a pair of selectable options. Referring to FIG. 8, an interface 800 is shown as presented on display 120 by processor 108 following a selection of element 324. Interface 800 is as described above in connection with interface 700, with the exception that interface 800 also includes a pair of selectable elements 804 and 808, for (respectively) generating a new task record, and a plurality of new task records linked by a decision record.

When the decision at block 245 is that a new task record is to be created, processor 108 performs block 250, at which a new task record is created in memory 112. A link identifying the new task record is inserted in the current task record (alternatively, a link to the current record may be stored in the new record). Following creation of the new record and storage of the link, the performance of method 200 continues at block 205, at which the new record is referred to as the current record and is populated as described above.

On the other hand, when the determination at block 245 indicates that the decision option 808 has been selected, processor 108 is configured to create a plurality of new records. The new records include a decision record linked to the current record as noted above, and a configurable number of task records each linked to the decision record as noted above. The number of new task records to be generated can be determined via a prompt presented on display 120. Following generation of the new records, each new task record is populated as described above, beginning at block 205.

The above-mentioned decision records are populated via the receipt of input data at processor 108 (e.g. from keyboard 116). In particular, in response to the selection of element 808, processor 108 is configured to present, on display 120, a decision record generation interface that includes an input field for the name of the decision record, and an input field for the number of branches from the decision record (that is, the number of possible outcomes of the decision). In response to receiving a number of branches, processor 108 can update the interface to provide a corresponding number of branch name input fields. Upon receipt of the branch names, processor 108 is configured to store the decision record (including the decision name and the names of the branches, as well as a link to the previous task record) and to generate a new task record corresponding to each branch.

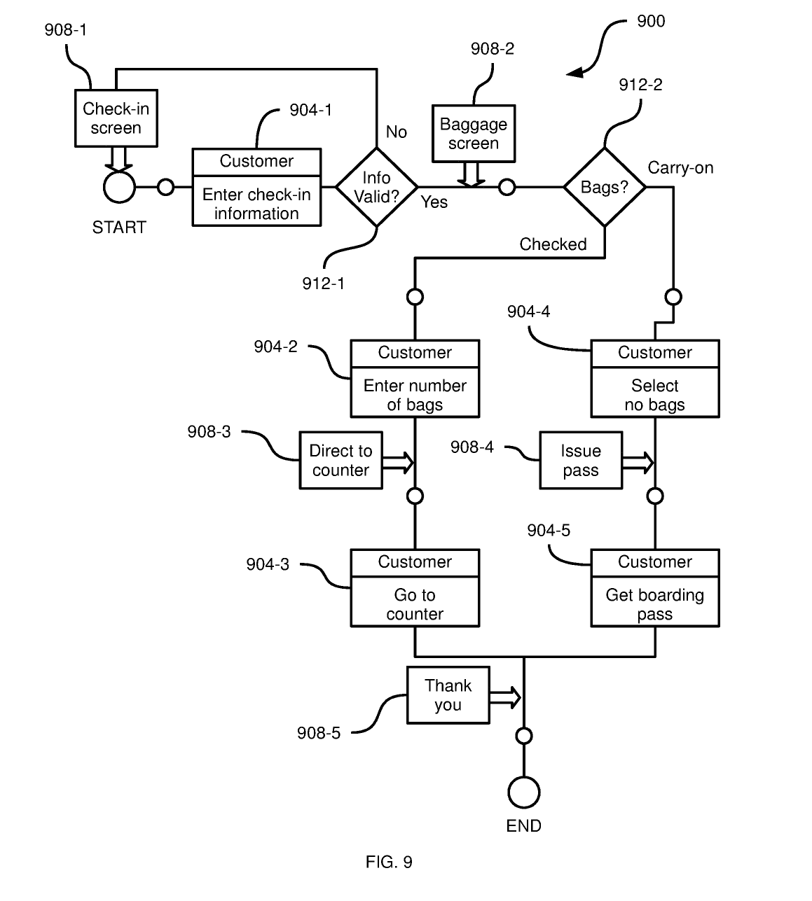

Referring now to FIG. 9, an example interface 900 present on display 120 is depicted, following multiple performances of method 200. In particular, a plurality of tasks 904-1, 904-2, 904-3, 900-4 and 900-5 (collectively referred to as tasks 900) are depicted, each with a prior state 908-1, 908-2, 908-3 and 908-4 (collectively referred to as prior states 904) representing a system task. A final system task 908-5 is also shown. In addition, two decisions 912-1 and 912-2 are shown, each having two branches with names as indicated in FIG. 9. The illustrated tasks and decisions together define a sequence of operations performed by the above-mentioned airline check-in application, in response to various inputs provided to the airline check-in application by a user.

Of note in FIG. 9 is that decision records 912-1 and 912-2 illustrate two different types of decisions. Decision 912-1 is a decision to be performed by the system (i.e. by the airline check-in application, in the present example), while decision 912-2 is a decision to be performed by the user of the system (i.e. the customer checking in). Both types of decisions The two types of decisions are distinguished by their positions relative to tasks 904 and prior states 908. In particular, a user decision is preceded by a single prior state 908 and followed by a plurality of tasks 904, while a system decision is preceded by a single task 904 and followed by a plurality of prior states 908. As will be discussed below, the data structure according to which decision records are stored depends on the type of decision. As will now be apparent, the selection of element 808 (shown in FIG. 8) can be followed by a further selection between selectable options for creating a system decision record or a user decision record.

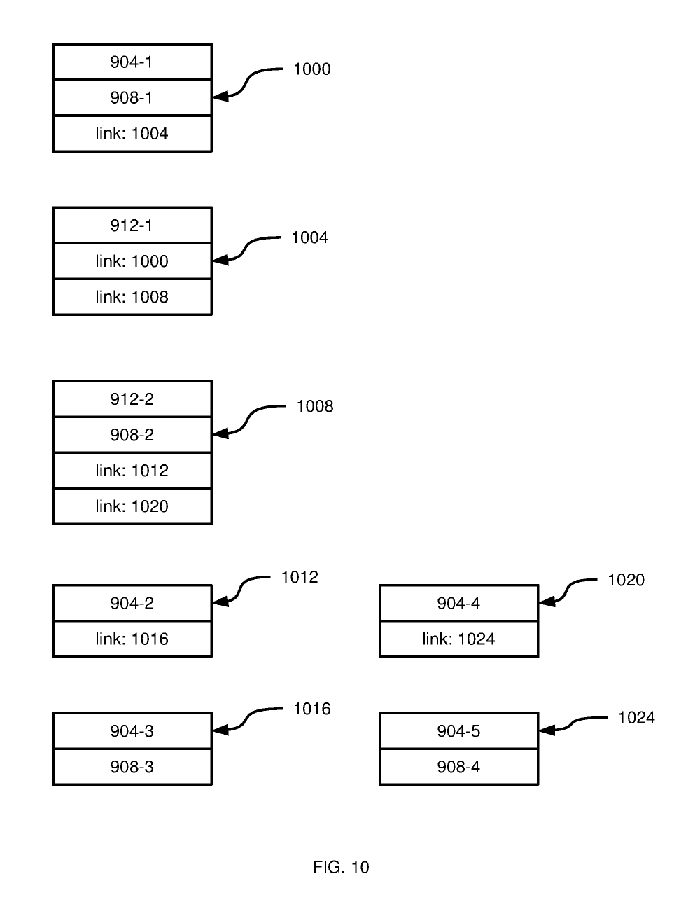

Turning now to FIG. 10, example task and decision records as stored in memory 112 are depicted, corresponding to the process flow shown in FIG. 9. In particular, a plurality of records 1000, 1004, 1008, 1012, 1016, 1020 and 1024 are shown as stored in memory 112. Each record contains record data defining a task or a decision, and may also contain a link to another record. Thus, for example, record 1000 contains the data defining task 904-1 and prior state 908-1, as well as a link to record 1004. Record 1004, meanwhile, contains the data defining decision 912-1, and links to record 1000 and record 1008. The records of FIG. 10, in other words, reconstruct the process flow shown in FIG. 9.

As will now be apparent to those skilled in the art, a variety of other record data structures may also be employed. For example, links may be stored in the downstream records instead of, or in addition to, being stored in the upstream records. Further, in some embodiments, prior state data may be stored separately from task data (and linked to the appropriate task data).

Of note, records 1012 and 1020 are distinguished from the remaining task records (e.g. records 1000 and 1016) in that records 1012 and 1020 do not contain prior state data. Instead, the prior state data (corresponding to prior state 908-2) shared by records 1012 and 1020 is contained in record 1008, which defines decision 912-2. In other embodiments, however, prior state 908-2 can be stored in each of records 1012 and 1020.

It is also noted that system task (i.e. the final system state) 908-5 is not shown in FIG. 10. Final state 908-5 can be stored in a variety of ways. In some example embodiments, state 908-5 can be stored in a separate data record, which can contain links to records 1016 and 1024. In other embodiments, records 1016 and 1024 themselves can contain links to the separate data record.

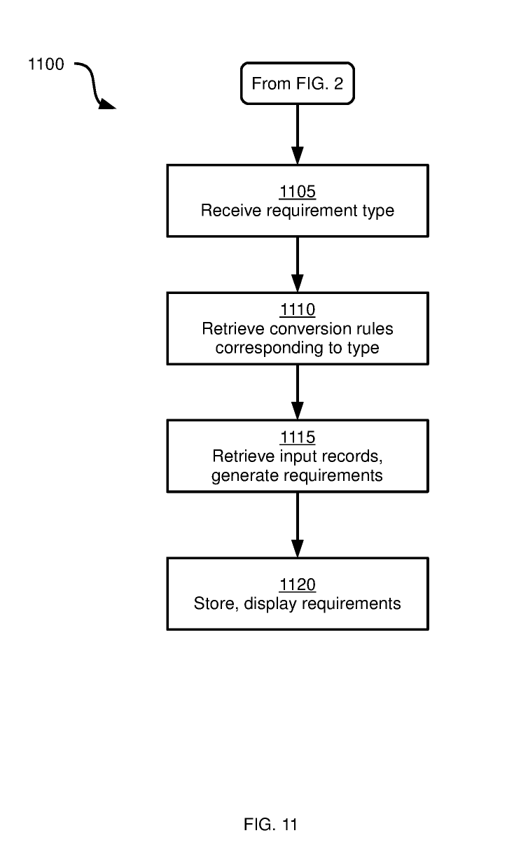

Returning to FIG. 2, when the determination at block 240 is negative, the creation of a set of records is complete, and the performance of method 200 can proceed to FIG. 11. FIG. 11 depicts a method 1100 of generating requirement data from the above-mentioned task and decision records. Method 1100 is a continuation of method 200, although it is contemplated that method 1100 and method 200 need not follow each other immediately. In some embodiments, the creation of records via method 1100 can precede the performance of method 1100 by any suitable time period. For example, method 1100 can begin only upon receipt by processor 108 of a command (e.g. via keyboard 116 or pointing device 118) to generate requirements from the records created through method 200. Such a command can include the receipt of a selection at processor 108 of a selectable element presented on an interface such as those mentioned above (e.g. that shown in FIG. 9).

Beginning at block 1105, processor 108 can be configured to receive a requirement type identifier. The requirement type identifier received at block 1105 can be received as input data from an input device. For example, the requirement type can be received as a selection of a requirement type identifier presented on display 120. In other embodiments, the receipt of the requirement type identifier can be automatic. For example, processor 108 can be configured to automatically generate various types of requirement data upon completion of method 200. It is also contemplated that the requirement type identifier received at block 1105 can include a plurality of requirement type identifiers.

The nature of the requirement type identifier or identifiers received at block 1105 is not particularly limited. In general, the identifiers can include identifiers of any known type of software design requirements, including use cases, test cases, simulations, user stories, and the like.

Having received at least one requirement type identifier at block 1105, processor 108 is configured to retrieve conversion rules 160 from memory 112. More specifically, processor 108 is configured to retrieve the subset of conversion rules 160 that correspond to the requirement type identifiers received at block 1105.

Conversion rules 160 specify, for each requirement type identifier, rules for creating requirement data elements from input records (i.e. the task and decision records discussed above). Thus, each set of rules corresponds to a particular requirement type, and includes a plurality of rules, each including an identifier of an input field, and an identifier of a requirement field into which the data from the identified input field is to be inserted. Examples of conversion rules 160 will be discussed below.

At block 1115, processor is configured to retrieve the records generated through the performance of method 200 (e.g. those shown in FIG. 10), and based on those records and the conversion rules retrieved at block 1110, to generate requirement data elements corresponding to the input records. Generating each requirement data element includes creating a new requirement data element, and populating the requirement data element from the input records according to the conversion rules.

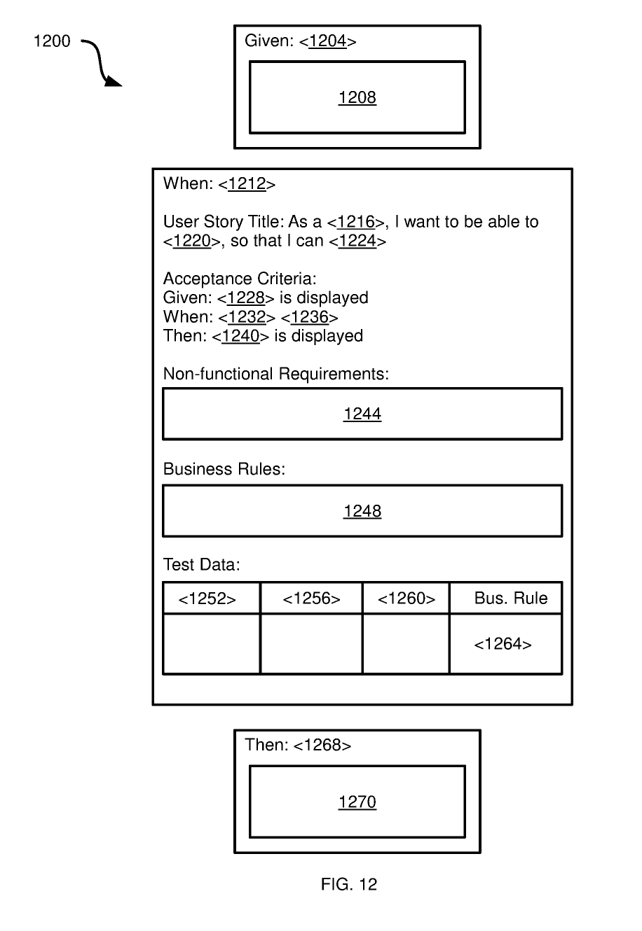

An example set of conversion rules for converting the input records to user story data elements is shown below in Table 1. The user story fields in Table 1 are illustrated in FIG. 12, which depicts an example user story interface 1200 generated on display 120.

TABLE 1
Example Conversion Rules for User Stories

| User Story Field | Input Field |
|---|---|
| 1204 | current prior state 508 |
| 1208 | current visualization 512 |
| 1212 | current action 308 |
| 1216 | current actor 304 |
| 1220 | current action 308 |
| 1224 | current objective 524 |
| 1228 | current prior state 508 |
| 1232 | current actor 304 |
| 1236 | current action 308 |
| 1240 | next prior state 508 |
| 1244 | |
| 1248 | |
| 1252 | current prior state 508 |
| 1256 | current action 308 |
| 1260 | next prior state 508 |
| 1264 | 1248 |
| 1268 | next prior state 508 |
| 1270 | next visualization 512 |

To generate user case data elements from scenario records based on the rules shown in Table 1, processor 108 is configured to select a task record (e.g. beginning with task record 1000, although the task records can be processed in any order and need not all be processed together). Each of the rows in Table 1 then specifies how the fields of the user story being generated are to be populated based on the selected task record (the “current” record), as well as certain data from the subsequent task record (the “next” record).

Fields 1244 and 1248, as shown above, are not populated from task or decision records. Instead, fields 1244 and 1248 are completed via the receipt of input data (e.g. from keyboard 116) following the generation of the user story. Field 1244 can receive one or more requirements referred to as “non-functional”. Such requirements for the application under development can include security features, throughput features and the like that do not directly affect the process flow shown in FIG. 9. Field 1248, on the other hand, can receive input data representing one or more business rules that modify the relevant stage of the process flow in FIG. 9. For example, a business rule may be received in connection with a user story generated from record 1012 (at which the user enters a number of bags) specifying that a number of bags greater than two should provoke a modified response from the system. Such a modified response may be, for example, a modified version of the “direct to counter” screen shown next by the system (see 908-3 in FIG. 9), advising the user that additional charges may apply for the number of bags entered. Business rules may be entered in field 1248 as strings of text, or as references to business rules stored elsewhere in repository 156.

Fields 1252, 1256, 1260 and 1264 together define a test data table to be completed via the receipt of input data. In particular, a record is created in the table for each business rule (that is, field 1264 can actually represent a number of different rows in the table). Input data defining prior state (1252), user action (1256), and expected system responses (1260) can be entered for each business rule (1264), permitting a tester of the application under development to specify tests for verifying that the business rules are satisfied. The table shown in FIG. 12 can be extended to contain any suitable number of test parameter records. For example, a plurality of records of test parameters (i.e. of rows in the table) may be entered to test a single business rule.

As will now be apparent to those skilled in the art, the user story interface illustrated in FIG. 12 includes what is typically referred to as a title, as well as a set of acceptance criteria presented according to the “given, when, then” format. Both the title and the acceptance criteria are generated automatically from the input data discussed earlier herein.

It is contemplated that more complex conversion rules may be provided to handle the automatic generation of user story elements from underlying task records that are adjacent to decision records. For example, conversion rules 160 may specify that when a task record is selected for conversion that is adjacent to a decision record, one user story element is generated for each branch of the decision. Further, field 1228 typically contains both the prior state data, as indicated in Table 1, and an identification of one of the branches of the decision. Thus, the “given” portion of the acceptance criterion for the user story data element centered on task 904-2 may be completed automatically to contain “Given: <Baggage screen> is displayed AND <Bags?> is <Checked>”. The “when” and “then” portions are completed according to Table 1. As will now be apparent, another user story data element may be automatically generated centered on task 904-4, having the same “given” portion as above, but having different “when” and “then” portions.

Returning to FIG. 11, having generated requirement data based on the scenario records and conversion rules, at block 1120 processor 108 can be configured to store the requirement data (e.g. the data shown in FIG. 12) in memory 112.

Various advantages to the above systems and methods will now occur to those skilled in the art. For example, the above systems and methods can lead to a reduction in the need (and storage requirements) for input data, particularly in connection with the generation of user stories, use cases and the like, by automatically assigning actor identifiers in certain use case data elements. Further, such automatic assignment can reduce the likelihood of erroneous input data being provided to processor 108, and thus reduce computational requirements and wear on input devices. Other advantages will also occur to those skilled in the art.

Variations to the above embodiments are contemplated. For example, in some embodiments, interfaces 300 and 500 can be presented simultaneously on display 120 (i.e. they can be part of a single interface). In further embodiments, processor 108 may be configured, in response to selection of a selectable element presented on display 120, to update an interface such as that shown in FIG. 9, to display only actor and action data (that is, to hide prior state data).

In further variations, the collection and storage of input data can be performed in a different manner than that described above. In the examples described above, each process is defined in data records 1000 by collecting input data corresponding to a plurality of tasks, each with a system task also referred to as either a prior state or a final state (i.e. a final system task).

In other embodiments, rather than receiving input data defining system tasks as prior state data, device 104 can receive input data defining a user task and a subsequent state, representing a system task that is performed by the application under development in response to the user task. User tasks and system responses (i.e. subsequent states) can be stored together in records 1000, rather than user tasks and prior states. In such variations, an initial state (also referred to as a pre-condition) replaces final state 908-5 as shown in FIG. 9. More specifically, in such variations, prior state 908-1 is stored as a separate initial state (i.e. an initial task performed by the application under development), while final state 908-5 is a system response, stored in connection with either or both of tasks 904-3 and 904-5.

More generally, the receipt of input data defining system tasks can take a variety of forms in addition to those described above. Further, input data defining system tasks can include any suitable combination of the types of input data described above in connection with user tasks. In other words, interfaces for receiving system task data (e.g. provided in interface 500, shown in FIG. 5A) can include fields or selectable elements beyond those shown in FIG. 5A, such as sub-process elements (similar to element 316), name and description fields, and the like.

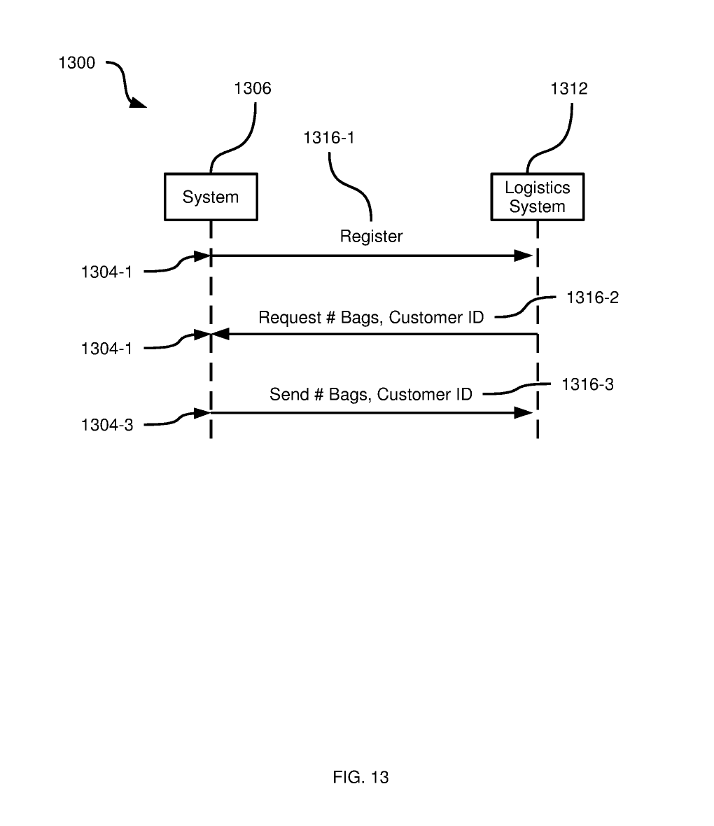

In further embodiments, device 104 can be configured to present alternative interfaces for collecting input data. For example, referring to FIG. 13, some system tasks (i.e. tasks to be performed by the application under development) can be directed to interactions between the system and other, external systems rather than between the system and a human user (such as the user performing the airline check-in procedure mentioned earlier). In such embodiments, device 104 can provide an alternative interface 1300 for collecting input data defining the system tasks, as well as the “user” tasks (that is, tasks performed by the above-mentioned external systems).

Interface 1300, as will now be apparent to those skilled in the art, is a sequence diagram, including a plurality of task elements 1304-1, 1304-2 and 1304-3 each defining a communication between the application under development (shown as the “system” at 1308) and an external system 1312, which in the present example (continuing with the airline check-in application described above) is an external logistics application with which the check-in application must interact. Each task element 1304 includes a task name or description 1316-1, 1316-2 and 1316-3 (as noted earlier, a plurality of fields, including any suitable combination of a label, a name and a description can be provided). In addition, each task element can include a visualization field similar to field 512 described earlier. In addition, each task element can include a sub-process element similar to element 316 described above.

Each task element can also be defined by a direction, as indicated by the direction of the arrows shown in FIG. 13. Decision elements, as well as the task elements illustrated in FIG. 13, can be generated, and the decision and task elements can be stored in memory 104 using the techniques described above in connection with FIG. 10. Additionally, user stories can be generated from the data collected via interface 1300 as described above, using conversion rules 160. In some embodiments, separate conversion rules may be stored in memory 104 for the conversion of sequence diagram data to user stories. Such conversion rules may, for example, specify a modified format for acceptance criteria from that shown in FIG. 12. For example, rather than populating a “given” field in a user story based on the previous system task with the string “<system task> is displayed”, the conversion rules may specify that the “given” portion of the acceptance criteria are populated with the string, “<system task> sent to <destination>”, where <destination> is indicated by the directionality of the arrows shown in FIG. 13. As will now be apparent, in part due to the above-mentioned directionality, interface 1300 can accommodate multiple external systems (that is, multiple “users”) each interacting with the application under development.

Further, as mentioned earlier, interface 300 can include a selectable delete element 312, which can be selected to delete the corresponding task record (e.g. to remove the “get boarding pass” task from FIG. 9). In addition, the selection of sub-process element 316 can lead to a further performance of method 200 for defining one or more task records that represent a separate process flow and are linked to a single task record in a main process flow. Thus, for example, the task “enter check-in information” in FIG. 9 can be stored in a record that links to a plurality of other task records representing a sub-process for performing that task.

The scope of the claims should not be limited by the embodiments set forth in the above examples, but should be given the broadest interpretation consistent with the description as a whole.

We claim:

1. A method of automatically generating output requirement data from task records, comprising:
at a processor, controlling a display connected to the processor to present at east one input interface having:
a first region including an actor input field and an action input field;
a second region including a system action input field;
receiving at the processor; from an input device, (i) first input data corresponding to the actor field, (ii) second input data corresponding to the action field, and (iii) third input data corresponding to the system action input field;
storing the first input data, the second input data, and the third input data in a task record in a memory connected to the processor;
at the processor, receiving a requirement data type;
retrieving, from the memory, a set of conversion rules corresponding to the received requirement data type;
at the processor, generating, based on the task record and the retrieved conversion rules, at least one element of output requirement data having the received input requirement data type; and
at the processor, controlling the display to present the at least one element of output requirement data.

2. The method of claim 1, further comprising:
responsive to receiving the first, second and third input data, determining whether the first, second and third input data is valid prior to storing the first, second and third input data.

3. The method of claim 1, further comprising:
responsive to storing the task record, receiving a selection of a record creation element on the display, for generating a further task record; and
repeating the controlling, the receiving of input data, and the storing of nput data.

4. The method of claim 3, further comprising:
prior to the repeating, presenting on the display at least two selectable task type elements on the display, and receiving a selection of one of the selectable record type elements.

5. The method of claim 4, further comprising:
responsive to selection of a task record type element, storing a link in the task record; and
responsive to selection of a decision record type element, storing a plurality of links in the task record.

6. The method of claim 1, wherein the at least one element of output requirement data comprises retrieving a plurality of conversion rules stored in the memory;
the conversion rules defining mappings between the first, second and third input data and the at least one element of output requirement data.

7. The method of claim 1, wherein presenting the element of output requirement data comprises presenting an output requirement interface on the display, the output requirement interface including a prompt for additional requirement data.

8. The method of claim 7, further comprising: receiving additional requirement data via the prompt, and storing the additional requirement data with the at least one element of output requirement data.

9. The method of claim 1, wherein displaying the at least one element of output requirement data comprises retrieving portions of a plurality of task records.

10. A computing device, comprising:
a display;
a memory;
an input device; and
a processor interconnected with the display, the memory and the input device, and configured to perform the method of claim 1.
